(19) United States
(12) Patent Application Publication
(10) Pub. No.: US 2026/0008485 A1
(43) Pub. Date: Jan. 8, 2026

(54) MULTI-PURPOSE RADIO CIRCUIT CARD FOR MANAGING RAIL CONSISTS RADIO COMMUNICATIONS

(71) Applicant: Amsted Rail Company, Inc., Chicago, IL (US)

(72) Inventor: Edward J. Mansfield, Blue Bell, PA (US)

(21) Appl. No.: 19/102,934

(22) PCT Filed: Oct. 29, 2024
(86) PCT No.: PCT/US2024/053333

§ 371 Date: Feb. 11, 2025

Related U.S. Application Data
(60) Provisional application No. 63/594,151, filed on Oct. 30, 2023.

(51) Int. Cl. B61L 15/00; B61L 25/02; H04L 67/12

(52) U.S. Cl. CPC B61L 15/0027; B61L 15/0072; B61L 25/025; H04L 67/12

(57) ABSTRACT

Systems and methods for operating a multi-purpose radio circuit (MPRC) of a locomotive. The methods comprise: establishing a connection between MPRC and a positive train control terminal located on the locomotive of a train consist (wherein a yard communication function of MPRC is disabled and a wireless gateway function of MPRC is enabled); performing the wireless gateway function by MPRC to manage a network of the train consist and/or a railcar of the train consist while the train consist is in route to a switch yard; detecting, by MPRC, that the locomotive is entering a geofence of the switch yard; enabling the yard communication function of MPRC responsive to said detecting; and performing the yard communication function to wirelessly communicate information from MPRC that is useful for switch yard management.

### RELATED APPLICATIONS

The present application claims priority to and the benefit of U.S. Provisional Patent Application No. 63/594,151 filed on Oct. 30, 2023. The content of this Provisional Patent Application is incorporated herein by reference in its entirety.

This patent document is related to U.S. Pat. Nos. 10,259,477, 10,850,755, 11,595,256, and 11,628,870. The disclosure of the listed U.S. Patents is fully incorporated in their entirety into this document by reference.

### BACKGROUND

### Description of the Related Art

In railcar transport systems, railcars are used to carry loose bulk commodities, liquid commodities and/or other types of goods by rail. Such goods may be loaded and unloaded at railyards. The locations of the railcars may change during different phases of a railyard management process. The phases include an inbound phase, a load/unload phase, and an outbound phase. A railyard map and scheduling system are used to coordinate movements of the railcars through the multiple tracks/paths of the railyard. The railyard map shows the locations of the railcars in the railyard, and any changes in the same as the railcars move through the railyard. The railyard map is updated manually using information obtained by individuals who are present in the railyard. This manual process is time consuming, error prone and dangerous to personnel.

### SUMMARY

The present disclosure concerns implementing systems and methods for operating a multi-purpose radio circuit of a locomotive. The methods comprise: establishing a connection between the multi-purpose radio circuit and a positive train control terminal located on the locomotive of a train consist, wherein a yard communication function of the multi-purpose radio circuit is disabled and a wireless gateway function of the multi-purpose radio circuit is enabled; performing the wireless gateway function by the multi-purpose radio circuit to manage a network (e.g., a train-based network of the train consist and/or a railcar-based network of a railcar) of the train consist while the train consist is in route to a switch yard; detecting, by the multi-purpose radio circuit, that the locomotive is entering a geofence of the switch yard; enabling the yard communication function of the multi-purpose radio circuit responsive to said detecting; and performing the yard communication function to wirelessly communicate information from the multi-purpose radio circuit that is useful for switch yard management.

The present disclosure also concerns a system, comprising: a positive train control terminal; and a multi-purpose radio circuit that is electrically connected the positive train control terminal. The multi-purpose radio circuit is configured to perform the following functions when a yard communication function of the multi-purpose radio circuit is disabled and a wireless gateway function of the multi-purpose radio circuit is enabled: (i) perform a wireless gateway function to manage a network (e.g., a train-based network of a train consist and/or a railcar-based network of a railcar) of the train consist while the train consist is in route to a switch yard; (ii) detect that a locomotive is entering a geofence of a switch yard; (iii) enable a yard communication function responsive to a detection that the locomotive is entering the geofence of the switch yard; and (iv) perform the yard communication function to wirelessly communicate information from the multi-purpose radio circuit that is useful for switch yard management.

### BRIEF DESCRIPTION OF THE DRAWINGS

This disclosure is facilitated by reference to the following drawing figures, in which like numerals represent like items throughout the figures.

FIGS. 1A-1B (collectively referred to herein as “FIG. 1”) provides an illustration of a system implementing the present solution.

FIG. 2 provides a perspective view of the multi-purpose radio circuit card shown in FIG. 1.

FIG. 3 provides a block diagram for the multi-purpose radio circuit card of FIGS. 1-2

FIG. 4 provides an illustration of the train consist shown in FIG. 1.

FIG. 5 provides an illustration of train consist with a train-based network and railcar-based networks.

FIG. 6 provides an illustration a communications system.

FIGS. 7A-7B (collectively referred to herein as “FIG. 7”) provide illustrations showing communication hops across a train consist.

FIG. 8 provides an illustration of an illustrative track arrangement of the railyard shown in FIG. 1.

FIG. 9 provides an illustration of an illustrative railyard map.

FIG. 10 provides an illustration of an illustrative graphical user interface (GUI) for a manager of a railyard.

FIG. 11 provides a flow diagram of an illustrative method for operating a multi-purpose radio circuit to provide at least a connected switch yard (or railyard) and train consist management system.

FIG. 12 provides a block diagram of an illustrative computing device.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Reference throughout this specification to features, advantages, or similar language does not imply that all of the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

As noted above, current switch yard processes are self-contained, manually intensive and time consuming. The present solution overcomes these drawbacks of conventional switch yard processes. In this regard, the present solution concerns a multi-purpose radio circuit card that can be plugged into the electronics of existing locomotive positive train control (PTC) terminals of locomotives. The PTC terminals may be disposed in locomotive cabins. The radio circuit card is configured to serve as the manager for a radio communication network of a train consist as well as serve as a two-way radio participant with a yard management radio system located in an approaching switch yard. Communication with radios on individual railcars of a train consist is consistent throughout the journey, whereas communication with a switch yard is engaged upon entering the switch yard's geofence and disengaged upon exiting the switch yard's geofence. As known in the art, a geofence generally comprises a virtual geographic boundary defined by, for example, global position system (GPS) or radio frequency identification (RFID) technology.

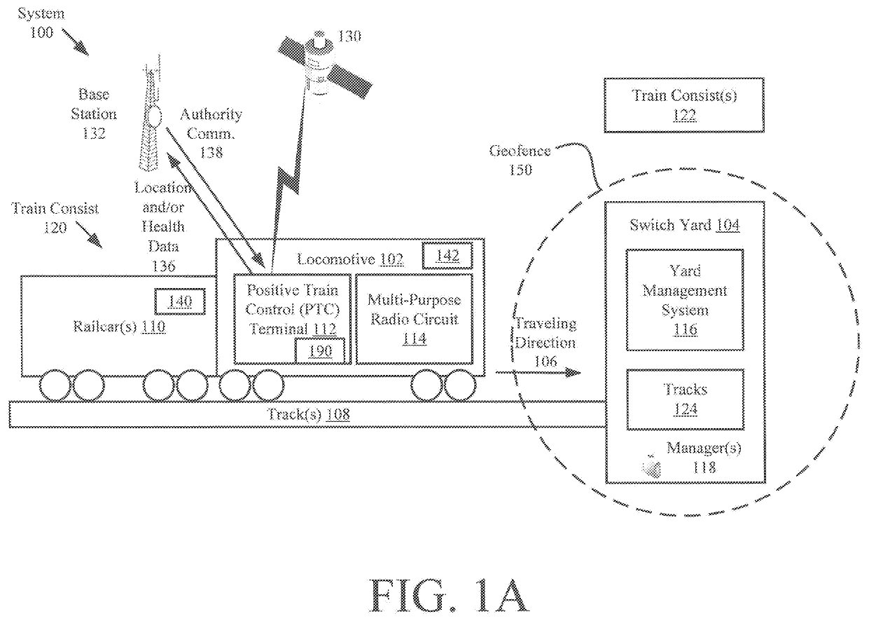

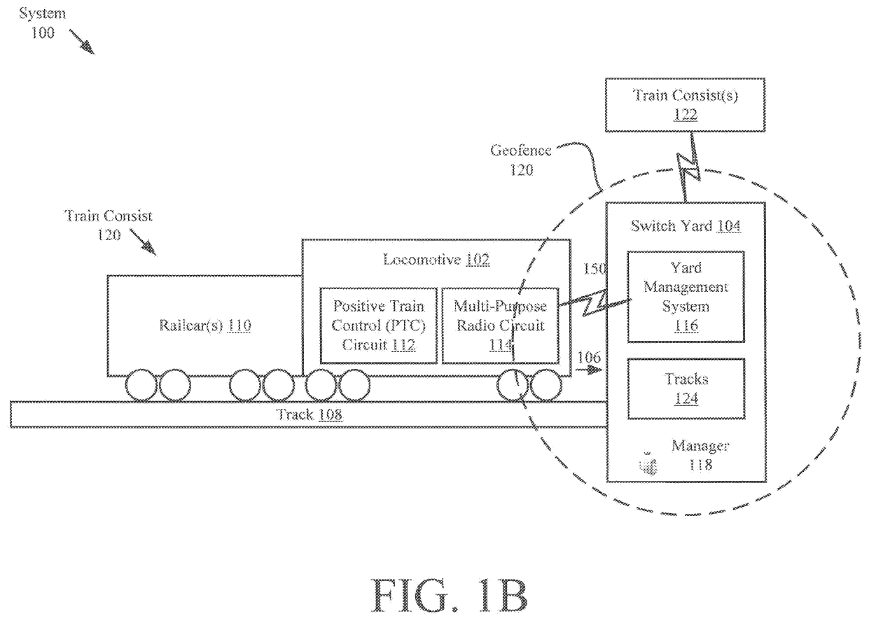

Referring now to FIG. 1, there is provided illustrations of a system 100 implementing the present solution. The present solution will be described herein in relation to switch yards. A switch yard generally comprises a series of tracks having switching turntable(s) in a rail network for storing, sorting and loading and unloading railcars and locomotives. The present solution is not limited in this regard, and can also be used with railyards. A railyard generally comprises a series of tracks in a rail network for storing, sorting and loading and unloading railcars and locomotives.

System 100 comprises one or more train consists 120, 122. Train consist 120 is traveling on track(s) 108 in direction 106 toward a switch yard 104. The other train consists 122 may also be traveling on tracks towards and/or away from the switch yard 104. The switch yard 104 comprises a yard management system 116 facilitating railyard management by a manager 118. Any known or to be known yard management system can be used here.

The train consist 120 comprises a locomotive 102 and railcar(s) 110. A positive train control (PTC) terminal 112 is provided with the locomotive 102. Any known or to be known PTC terminal can be used here. The PTC terminal 112 is generally configured to wirelessly communicate with authorities and/or other parties via base station(s) 132 and/or other communication means. These communications are intended to facilitate prevention of train-to-train collisions, over-speed derailments, incursions into established work zones, and movements of trains through switches left in the wrong position. In this regard, the PTC terminal 112 may continuously or periodically send train consist location and/or heath data to the authorities and/or other parties. The health data can include, but is not limited to, sensor data generated by sensor(s) 140 on the railcar(s) 110 and/or sensor data generated by sensor(s) 142 on the locomotive 102. Sensors 140, 142 can include, but are not limited to, cameras, accelerometers, vibration sensors, orientation sensors, temperature sensors, humidity sensors, and/or odor/sent/smell sensors. Accordingly, the sensor data can include, but is not limited to, temperature measurements, acceleration measurements, vibration measurements, operational status information (e.g., open or closed hatch, open or closed valve, etc.), moisture measurements, and/or weight measurements. The location of the train consist 120 may be obtained using satellite(s) 130 of a global navigation satellite system (GNSS) (e.g., global positioning system (GPS)). The authorities may use the location and/or health data to generate command and control messages for the train consist 120. The command and control messages can be sent from the authorities to the PTC terminal 112 via communication link 138. Each command and control message may, for example, cause the train consist 120 to slow down, speed up, stop and/or change tracks.

As shown, a multi-purpose radio circuit 114 is provided with the locomotive 102 in addition to the PTC terminal 112. The multi-purpose radio circuit 114 is electronically and communicatively coupled to the PTC terminal 112. This coupling can be wired or wireless. The multi-purpose radio circuit 114 may optionally be plugged into a port or circuit card slot of the PTC terminal 112. In this case, the multi-purpose radio circuit 114 may be a plug-and-play (PnP) device. Integration of the multi-purpose radio circuit 114 into the PTC terminal 112 effectively introduces a locomotive gateway feature to the PTC terminal 112. The locomotive gateway serves as the radio manager for the consist radio communication network as well as a two-way radio participant with the yard management system located in an approaching switchyard. The radio communication network may be a self-healing low-power wide-area (LPWA) based network, whereas the switch yard communication network can be based on a number of non-cellular digital communication formats.

The multi-purpose radio circuit 114 is configured to (i) collect location data, sensor data and/or health data from sensor(s) 140, 142 of the train consist 120, and (ii) communicate the collected data to external devices (e.g., via base station 132). The multi-purpose radio circuit 114 also introduces a data connection of multiple intelligence threads from train consist and switch yard management mechanisms by providing a harmonized onboard system to facilitate the streamlining of the switch yard planning process. The collected data can include any type of data in accordance with a given application. In this regard, the multi-purpose radio circuit 114 is configured to further (iii) manage a train-based network and railcar-based networks of the train consist 120 when located in and outside of the geofence 150 of the switch yard 104, and (iv) communicate with a yard management system 116 of the switch yard 104 when located within the geofence 150 of the switch yard 104 (as shown in FIG. 1B). The multi-purpose radio circuit 114 may not communicate with the yard management system 116 of the switch yard 104 when located outside of the geofence 150 of the switch yard 104. Accordingly, operations (iv) may be selectively automatically disabled (or disengaged) when the train consist 120 is outside of the geofence 150 and selectively automatically enabled (or engaged) when the train consist 120 is inside the geofence 150. Any known or to be known yard management system can be used here with some modifications to allow information to be received from multi-purpose radio circuits of train consists and processed for managing operations of the switch yard.

In some scenarios, operations (iii) and (iv) are achieved using the same communication technology for the train-based network, railcar-based networks, switch yard-based network, and/or any network that provides communication. The same or different frequencies and/or frequency bands can be used. However, different network identifiers are employed for the train-based network, railcar-based networks and switch yard-based network. For example, a first network identifier is used for the train-based network, a second different network identifier is used for each of the railcar-based networks, and a third different network identifier is used for the switch yard-based network. The present solution is not limited in this regard. In other scenarios, operations (iii) and (iv) are achieved using different communication technologies and/or different frequency bands for the train-based network, railcar-based networks and/or switch yard-based network. The same network identifier can be used in this scenario for the train-based network, railcar-based networks and switch yard-based network.

Various types of information can be communicated from the multi-purpose radio circuit 114 to the yard management system 116 over communication link 150 shown in FIG. 1B. This information can include, but is not limited to, train consist location, train consist speed, an estimated time of arrival (ETA), railcar identifiers (IDs), railcar load type(s), railcar order, railcar switch-in information (or train consist formation information), railcar switch-out information (or train consist deformation information), and/or sensor data. The sensor data can include, but is not limited to, a hand brake status (e.g., on or off), a hatch status (e.g., closed or open), a load temperature, a bearing temperature, wheel damage, track/route anomalies, and/or environmental data. The sensor data can assist the yard management system 116 with scheduling maintenance of the railcar(s) 110 prior to directing the railcar(s) to track(s) for use in formation of other train consists. The track/route anomalies can include, but are not limited to, a track defect, a track under maintenance or repair, an unexpected or unanticipated object on a track, and/or an unexpected or unanticipated obstruction blocking a route. The environmental data may specify weather events. The track/route anomalies and/or weather events can be communicated from the yard management system 116 to other train consist(s) 122 in route to the switch yard 104 and/or within the switch yard 104. The yard management system 116 may also communicate switch-in information (or train consist formation information) and/or railcar switch-out information (or train consist deformation information) to the other train consist(s) 122.

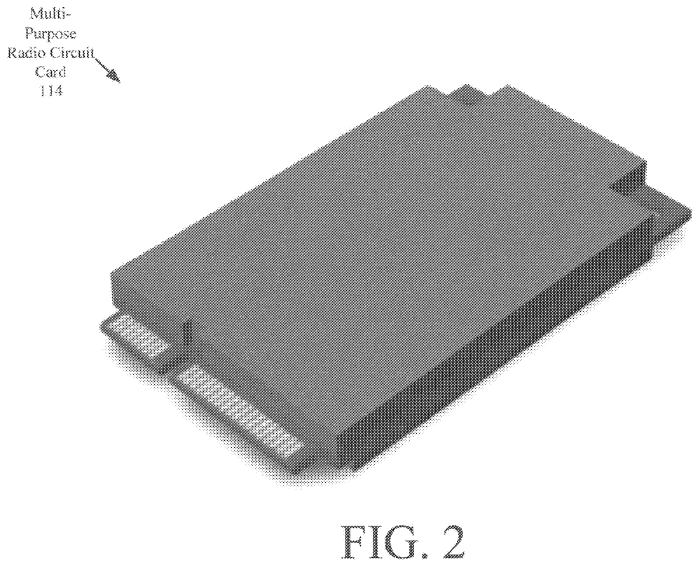

A perspective view of the multi-purpose radio circuit 114 is provided in FIG. 2. As shown, the multi-purpose radio circuit 114 can comprise a circuit card configured to be plugged into the PTC terminal 112. The present solution is not limited to this circuit card architecture. The multi-purpose radio circuit may alternatively comprise a standalone product that can have a wired or wireless connection to the PTC terminal 112.

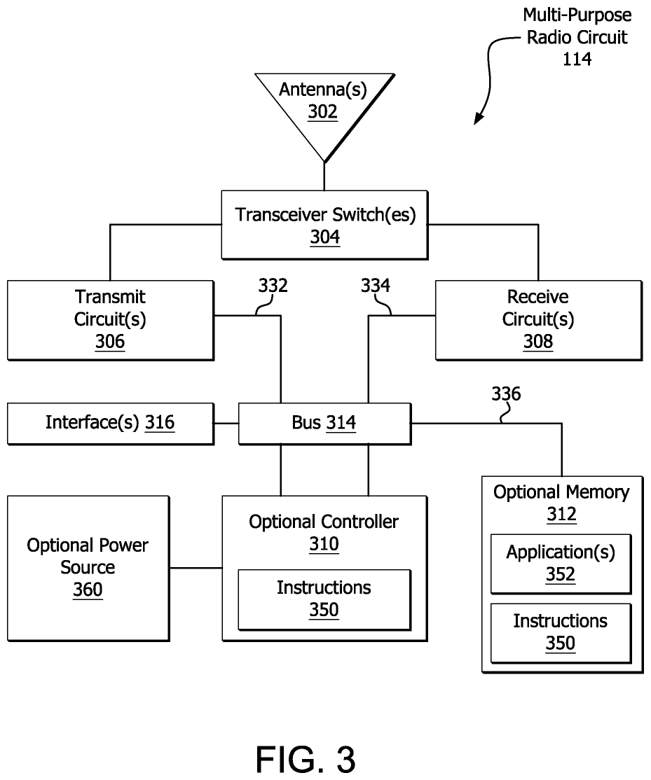

An illustrative block diagram for the multi-purpose radio circuit 114 is provided in FIG. 3. Multi-purpose radio circuit 114 may include more or less components than those shown in FIG. 3. However, the components shown are sufficient to disclose an illustrative hardware architecture implementing the present solution. The hardware architecture of FIG. 3 represents one embodiment of a representative multi-purpose radio circuit configured to facilitate integration of management for a train consist-based network, railcar-based networks, a switch yard-based network, and PTC functions. The operations and functions can include, but are not limited to, collecting sensor data from sensor(s) of the railcar(s) and/or locomotive, performing sensor data analysis to detect operational conditions of railcars and its components, determining a location of the train consist, and communicating information to/from external devices.

As shown in FIG. 3, the multi-purpose radio circuit 114 comprises antenna(s) 302 for receiving and transmitting wireless signals (e.g., RF signals, cellular signals, and/or satellite signals). Transceiver switch(es) 304 selectively couples the antenna(s) 302 to transmit circuit(s) 306 and receive circuits 2308 in a manner familiar to those skilled in the art. The present solution is not limited in this regard. The multi-purpose radio circuit 114 can alternatively comprise one or more antennas for each transceiver circuit 306 and 308, and therefore may be absent of the transceiver switch 204 for selectively connecting a transmit circuit and a receive circuit to a common antenna.

Transmit and receive circuits are well known in the art, and therefore will not be described in detail herein. Still, it should be understood that the transmit circuit 306 is configured to (i) cause information to be transmitted to an external device (e.g., base station 132, yard management system 116 and/or PTC terminal 112 of FIG. 1) via wireless signals, while the receive circuit 308 is configured to (ii) process wireless signals received from the external device to extract information therefrom. The transmit and receive circuits 306, 308 are coupled to a controller 310 via respective electrical connections 332, 334 to a system bus 314. The controller 310 is optional meaning that it can reside on the circuit board of the multi-purpose radio circuit 114 or alternatively be part of the PTC terminal.

In a transmit mode, the controller 310 also provides information to the transmit circuit 306 for encoding and modulating information into wireless signals. The transmit circuit 306 communicates the wireless signals to the antenna 302 for transmission to an external device (e.g., base station 132, yard management system 116 and/or PTC terminal 112 of FIG. 1). In a receive mode, the receive circuit 308 provides decoded wireless signal information to the controller 310. The controller 310 uses the decoded wireless signal information in accordance with the function(s) of the multi-purpose radio circuit 114.

The controller 310 stores the decoded wireless signal information and the decoded location information in a memory 312. Memory 312 is optional meaning that it can reside on the circuit board of the multi-purpose radio circuit 114 or alternatively be part of the PTC terminal. In either case, memory 312 is connected to and accessible by the controller 3210 through an electrical connection 336. The memory 312 may be a volatile memory and/or a non-volatile memory. For example, the memory 312 can include, but is not limited to, a Random Access Memory (RAM), a Dynamic Random Access Memory (DRAM), a Static Random Access Memory (SRAM), a Read-Only Memory (ROM), and/or a flash memory.

As shown in FIG. 3, one or more sets of instructions 350 are stored in the memory 312. The instructions 350 can also reside, completely or at least partially, within the controller 310 during execution thereof. In this regard, the memory 312 and the controller 310 can constitute machine-readable media. The term “machine-readable media”, as used here, refers to a single medium or multiple media that store the one or more sets of instructions 350. The term “machine-readable media”, as used here, also refers to any medium that is capable of storing, encoding or carrying the set of instructions 350 for execution by the controller 310 and that cause the multi-purpose radio circuit 114 to perform one or more of the methodologies of the present disclosure.

The controller 310 is also connected to interface(s) 216 and a power source 360. Power source 360 is optional meaning that it can reside on the circuit board of the multi-purpose radio circuit 114 or alternatively be part of the PTC terminal. Power source 360 can include, but is not limited to, a battery, an internal power generator, external power source, and/or an energy harvesting circuit. The energy harvesting circuit is generally configured to harvest energy from a surrounding environment that can be used to power the electronic components of the multi-purpose radio circuit 114. The harvested energy can include, but is not limited to, light, RF energy, vibration and/or heat.

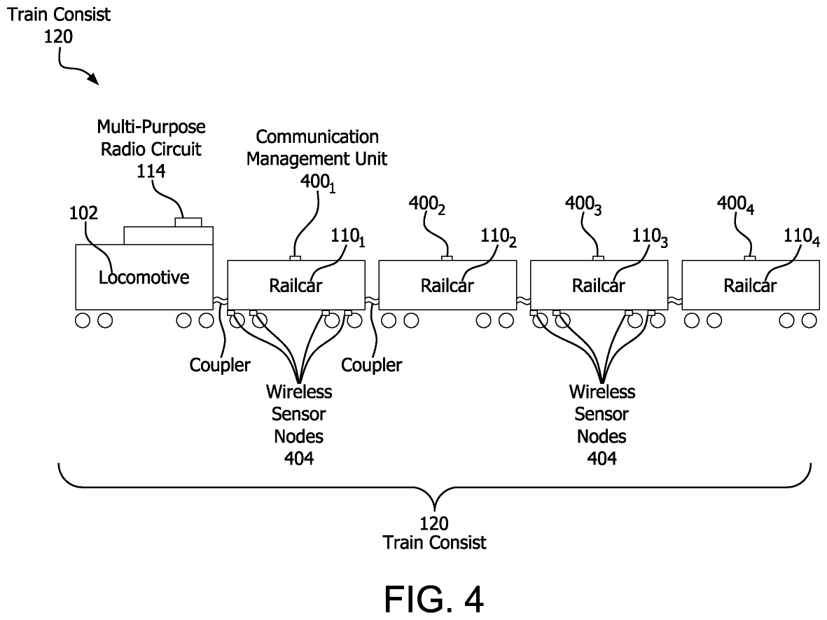

Referring now to FIG. 4, there is provided an illustration of the train consist 120. A train consist refers to a connected group of one or more railcars and locomotives. For example, as illustrated in FIG. 4, the train consist 120 may include a locomotive 102 and railcars 1101, 1102, 1103, 1104 (collectively referred to as “110”). The locomotive 102 includes the multi-purpose radio circuit 114 which is configured to act as a powered wireless gateway. The railcars 110 may include one or more data collection units. The data collection units can include, but are not limited to, wireless sensor nodes (WSNs) 404 and/or communication management units (CMUs) 4001, 4002, 4003, 4004 (collectively referred to as “400”). The present solution is described below in relation to WSNs and CMUs. The present solution is not limited in this regard. Other data collection units can be used in addition to or as an alternative to the WSNs and CMUs.

Each WSN 404 may have a self-contained, protective housing, and may include one or more sensors, a power source and communication circuitry which allows the WSN to communicate with one or more other devices such as, for example, CMUs 400, the multi-purpose radio circuit 114, a remote processing device, a railroad operations center and/or the like. The WSN may also include an intelligent capability to analyze the data collected from the sensors and to determine if the data needs to be transmitted immediately, held for later transmission, or aggregated into an event or alert. The WSN may be used for sensing a parameter to be monitored (e.g., temperature of bearings or ambient air) or status (e.g., position of a hatch or hand brake). The WSN may form part of a wireless communication network as described in more detail below. The WSN may include an accelerometer or other motion sensors, and/or one or more sensors to sense or measure vibrations, acceleration, centrifugal force, geography, or link margin data. The WSN may include a humidity sensor, a magnetometer, a barometric pressure sensor, an atmospheric sensor and/or other sensors.

Example train and/or rail communication and sensor systems are disclosed in, for example, U.S. Pat. No. 7,688,218 which issued Mar. 30, 2010, U.S. Pat. No. 9,026,281 which issued May 5, 2015, U.S. Pat. No. 9,365,223 which issued Jun. 14, 2016, PCT Publication WO 2015/081278 which published Jun. 4, 2015, PCT Publication WO 2015/100425 which published Feb. 7, 2015, PCT Publication WO 2016/191711 which published Dec. 1, 2016, U.S. Pat. No. 8,212,685 which issued Jul. 3, 2012, U.S. Pat. No. 8,823,537 which issued Sep. 2, 2014, U.S. Pat. No. 9,663,124 which issued May 30, 2017, U.S. Pat. No. 7,698,962 which issued Apr. 20, 2010, U.S. Pat. No. 9,026,281 which issued May 5, 2015, U.S. Pat. No. 9,663,092 which issued May 30, 2017, U.S. Pat. No. 9,365,223 which issued Jun. 14, 2016, U.S. Pat. No. 9,981,673, issued May 29, 2018, and U.S. Pat. No. 10,137,915 which issued Nov. 27, 2018. The full disclosures of the listed Patent documents are incorporated herein by reference in their entireties.

All WSNs 404 on a single railcar 110₁, 110₂, 110₃, 110₄ may be in communication with a CMU 400₁, 400₂, 400₃, 400₄, the multi-purpose radio circuit 114, a remote processing device, a remote railroad operations center and/or the like. Examples of WSNs are disclosed in U.S. Pat. No. 9,365,223, the disclosure of which is hereby incorporated by reference herein.

A CMU 400₁, 400₂, 400₃, 400₄ may be located on each railcar 110₁, 110₂, 110₃, 110₄. Each CMU may include a processor, a power source (e.g., a battery, solar cell or internal power-generating capability), and/or a global navigation satellite system (GNSS) device. The CMU may also include Wi-Fi, satellite, and/or cellular capability, a wireless communications capability (e.g., the presence of a communication network and/or signal strength), a compass, and, optionally, one or more sensors, including, but not limited to, a motion sensor, an impact detection sensor, an accelerometer, a gyroscope, acoustic sensor, vibration sensor, or temperature sensor. The CMU may support one or more WSNs 404 using open standard protocols, such as the IEEE 2.4 GHz 802.15.4 radio standard.

The CMU 400₁, 400₂, 400₃, 400₄ may include a magnetometer to associate railcar orientation with set and measured train consist parametrics. The magnetometer may have the north and south polarity points aligned with the coupler ends of each railcar during device installation. This is to assist with train consist configuration during yard management as some rail cars have ingress/egress points for the transported asset on only one side or in one vehicle area, making alignment critical for sequential train consist loading and unloading, assembly and disassembly activities in a rail yard.

CMUs 400 may communicate wirelessly with the multi-purpose radio circuit 114, or may be configured to communicate through a wired connection, for example, through the ECP (electronically controlled pneumatic) brake system. The CMUs 400 may communicate with a remote processing device or a remote railroad operations center. The CMUs 400 may include GNSS device(s) which may be used to determine location, direction and/or speed of a railcar. Types of GNSS receivers include, without limitation, GPS sensors, GLONASS, Galileo, BeiDou, and/or the like.

Each CMU 400₁, 400₂, 400₃, 400₄ may be capable of receiving data and/or notifications (e.g., alerts or alarms) from one or more WSNs 404 and is capable of drawing inferences from this data or notifications regarding the performance of railcar, and of transmitting data and notification information to a remote receiver, remote processing device and/or remote railroad operations center. The CMU may be a single unit that would serve as a communications link to other locations, such as a mobile base station (e.g., the locomotive 102), a land-based base station, etc., and have the capability of processing the data received.

The multi-purpose radio circuit 114 is located on the locomotive 102. The multi-purpose radio circuit 114 may include a processor, a GNSS device, a communication device such as, for example, a satellite and or cellular communication system, local wireless transceiver (e.g. WiFi), an Ethernet port, a high capacity network manager or other means of communication, and/or a gyroscope. The high capacity network manager can include, but is not limited to, a network manager (e.g., a mesh network manager). The multi-purpose radio circuit 114 may have power supplied by the locomotive 102, if located on a powered asset, such as a locomotive, or will derive its power from another source, for example, from a solar power generator or from a high-capacity battery.

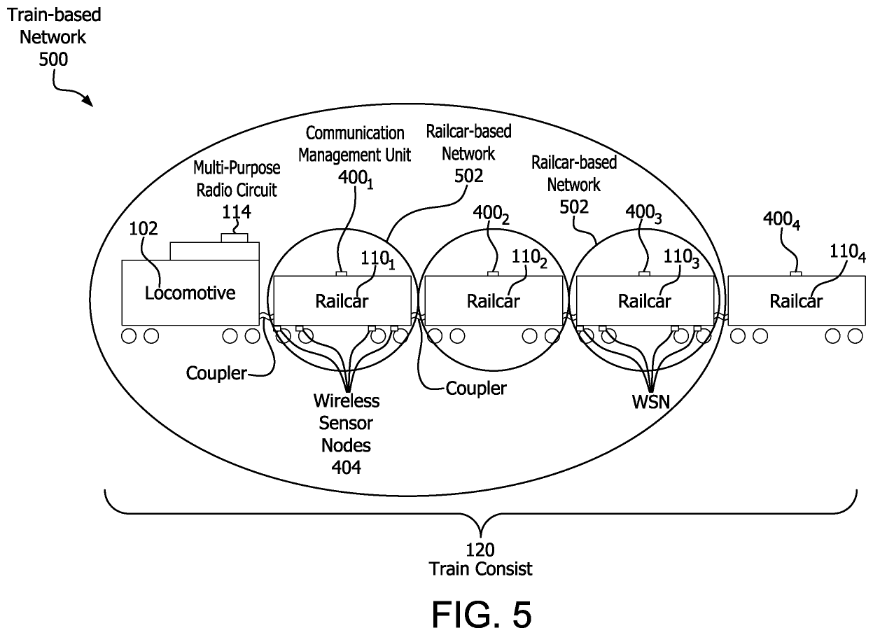

One or more networks may be used to facilitate communication within the train consist 120, or between the train consist 120 and a remote device, system or location. It is understood that any suitable type of network may be used within the scope of this disclosure. FIG. 5 illustrates examples of various types of networks that can be employed.

As shown in FIG. 5, a railcar-based network 502 may include a CMU 400₁, 400₂, 400₃, 400₄ installed on a railcar 110₁, 110₂, 110₃, 110₄ and WSN(s) 404 installed on the same railcar. All WSNs 404 on a single railcar may form a railcar-based network 502 that is controlled by the CMU. The CMU may support one or more WSNs 404 in a network configuration using open standard protocols, such as the IEEE 2.4 GHz 802.15.4 radio standard. Additionally, the CMU may also be a member of a train-based network 500, which may include the CMUs from all enabled railcars in the train consist 120, controlled by the multi-purpose radio circuit 114 located on a locomotive 102.

Each CMU 400₁, 400₂, 400₃, 400₄ may support at least the following four functions: 1) to manage a low-power railcar-based network 502 overlaid on a railcar 110₁, 110₂, 110₃, 110₄; 2) to consolidate data from one or more WSNs 404 in the railcar-based network 502 and to apply logic to the data gathered to generate warning alerts to a host such as a locomotive 102 or remote railroad operations center; 3) to support built-in sensors, such as an accelerometer, within the CMU to monitor specific attributes of the railcar 110₁, 110₂, 110₃, 110₄ such as location, speed, accelerations and more; and 4) to support bi-directional communication upstream to the host or control point, such as a locomotive 102 and/or an off-train monitoring and remote railroad operations center, and/or downstream to one or more WSNs 404 located on the railcar. CMUs 400 may communicate wirelessly to the multi-purpose radio circuit 114 in a network configuration, or may be configured to communicate through a wired connection, for example, through the ECP (electronically controlled pneumatic) brake system. Those skilled in the art will appreciate that GPS is just one form of a global navigation satellite system (GNSS). Other types of GNSS include GLONASS, Galileo, and BeiDou with others in development. Accordingly, although GPS is used in the embodiments described herein, any type of GNSS system or devices may be used.

The multi-purpose radio circuit 114 also controls the train-based network 500 overlaid on a train consist 120, consisting of multiple CMUs 400 from each railcar 110₁, 110₂, 110₃, 110₄ in a train consist 120, isolated CMUs that are not part of a train consist, or a rail yard-based network overlaid on a rail yard, consisting of land-based PWGs and CMUs from individual railcars not currently associated with a train consist 120.

The train-based network 500 is comprised of the multi-purpose radio circuit 114 and one or more CMUs 400, each belonging to the train-based network 500 and to their respective railcar-based networks 502, if one or more WSNs 404 are present, or respective railcar-based networks 502 for railcars with a CMU but no WSNs. Thus, here, the CMUs 400 can belong to two networks, the railcar-based network 502 (if a railcar is fitted with one or more WSNs 404) and the train-based network 500. Each CMU is also optionally managing its respective railcar-based network 502. The railcar-based network 502 is continually monitored by the CMU and is optimized for the ever changing wireless environment that a moving railcar experiences. Train-based network 500 uses an overlay network to support low-power bi-directional communication throughout train consist 120 and with the multi-purpose radio circuit 114 installed on locomotive 102. The overlaid train-based network 500 is composed of wireless transceivers embedded in the CMU 400₁, 400₂, 400₃, 400₄ on each railcar 110₁, 110₂, 110₃, 110₄. Each CMU 400₁, 400₂, 400₃, 400₄ is capable of initiating a message on the train-based network 500 or relaying a message from or to another CMU or from a WSN 404. The overlay train-based network 500 is created independently of, and operates independently of the railcar-based networks 502 created by each railcar in the train consist 120.

The multi-purpose radio circuit 114 is a bi-directional communication device configured to manage the train-based network 500, receive notifications or events (e.g., alerts or alarms) from the CMUs 400 and/or WSN(s) 404, and communicate the received notifications or events to a host or control point (e.g., such as the locomotive 102) where the notifications or events may be acted upon via human intervention or an automated system. Locomotive 102 may include a user interface for receiving and displaying notification messages and/or event messages generated by the train-based network 500. The multi-purpose radio circuit 114 is capable of receiving multiple alerts, events or raw data from WSNs 404 through CMUs 400 on individual railcars 110 and can draw inferences about specific aspects of the performance of train consist 120.

A distributed complex event processing (DCEP) engine may be used. A DCEP engine refers to a hierarchical system for collecting and analyzing data and for communicating data and/or notifications to a final destination where they can be acted upon. The DCEP engine may be responsible for implementing the intelligence used to draw conclusions based on the data collected from WSNs 404, CMUs 400 and/or multi-purpose radio circuit 114. The DCEP engine may be distributed among all or a portion of the WSNs 404, CMUs 400 and the multi-purpose radio circuit 114 on the locomotive 102, as well as utilizing a cloud-based infrastructure optimized to work closely with train-based networks, in conjunction with a variety of data streams from third-party providers or external sources.

If an alert or event condition is detected by a WSN or other sensor, such as when broken track or rough/choppy track is encountered, the WSN 404 may forward a message to the CMU 400 within its network for further analysis and action. For example, to confirm or coordinate alert or event conditions reported by one WSN 404 with other WSNs 404 in the railcar based network. If an event requiring notification is confirmed by CMU 400, a notification of the event may be sent to the multi-purpose radio circuit 114.

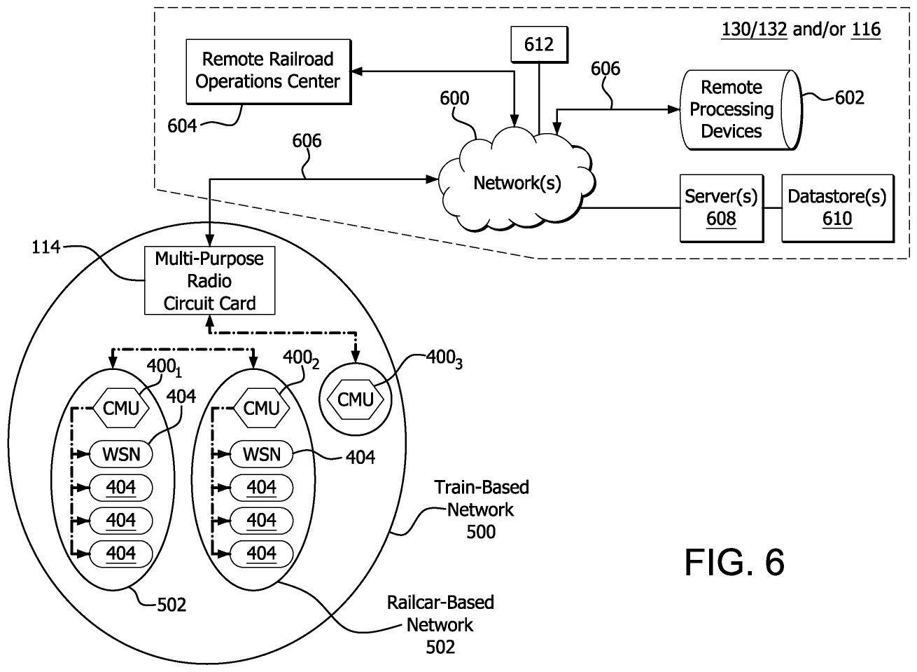

The multi-purpose radio circuit 114 is capable of exchanging information with an external remote railroad operations center, data system or other train management systems. This communication network (such as network 600 shown in FIG. 6) may include cellular, LAN, Wi-Fi, Bluetooth, satellite, or other means of communications. This link may be used to send notifications of events and alarms off-train when the train consist is in operation. This link may also be used to send instructions and information from the remote railroad operations center or other off train source to the individual railcar CMU 400, such as updated geofence coordinates to be used by the CMUs 400 when determining if a discharge gate related event has occurred.

A notification may provide information for inter alia, operations and security. The notification may include location of the event, time of the event, status of the event, duration of the event and alerts. The term notification may include any information such as alarms, alerts, event details, and data communicated by the CMU 400, WSN 404 and/or multi-purpose radio circuit 114 for the purpose of notifying persons or other systems of the information. The notification event may be communicated immediately or at some future time depending on the urgency and/or criticalness of the event.

As shown in FIG. 6, the multi-purpose radio circuit 114 may be in communication with remote processing device(s) 602 (e.g., server(s)) via the communication network 600 and/or a remote railroad operations center 604 via the communication network 400. The communication network 600 may include, without limitation, cellular, LAN, Wi-Fi, Bluetooth, satellite, or other means of communications. Although FIG. 6 illustrates communication between the multi-purpose radio circuit 114 and remote processing device(s) 602 and/or a remote railroad operations center 604, one or more CMUs and/or WSNs may communicate directly with the remote processing device(s) 602 and/or remote operations center 604 via one or more communication networks.

The remote processing device(s) 602 may maintain a machine learning model trained to predict one or more network adjustments as discussed in more detail below. An on-board system may measure stimuli that either affects communication integrity or exceeds specified threshold value(s), and may report detected occurrence(s) to a machine learning model for consideration. The machine learning model may, in turn, perform descriptive analytics (e.g., “what has happened?”), predictive analytics (e.g., “what could happen?”) and/or prescriptive analytics (“what should we do?”).

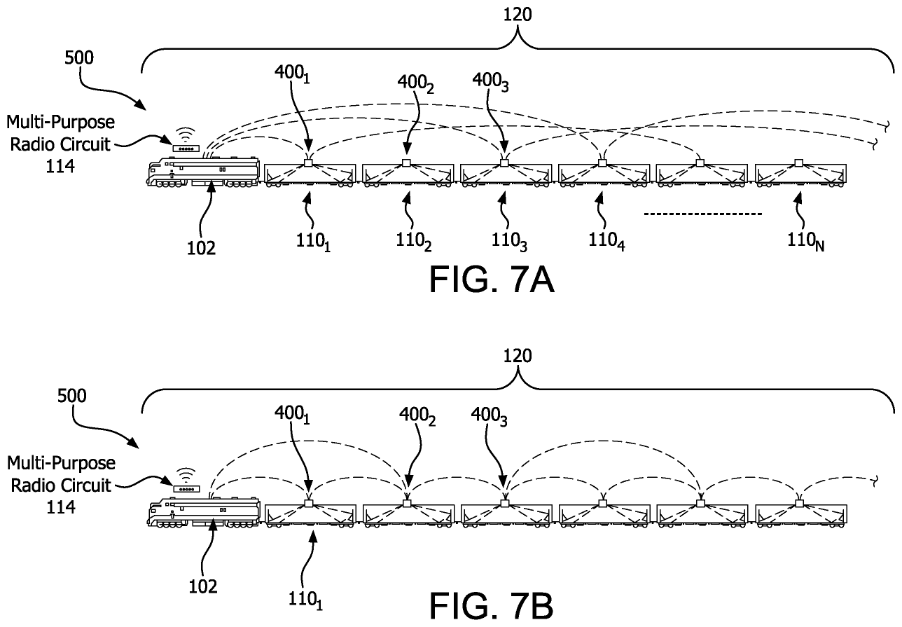

FIGS. 7A and 7B illustrate an example information communication technology (ICT) network system for train consist 120. The train-based network 500 may use a wireless network to provide bi-directional communication from one or more railcars 110 in a train consist 120 to a host or control point, such as, for example a locomotive 508. It should be noted that train consist 120 was described above as comprising four railcars. The present solution is not limited in this regard. The train consist 120 can include any number N of railcars selected in accordance with a particular application, where N is an integer. Thus, FIGS. 7A-7B show N railcars in the train consist 120. FIGS. 7A-7B can be easily modified to accommodate a reduced number of railcars.

The multi-purpose radio circuit 114 is configured to manage the train-based network 500 and to communicate information (e.g., notifications, alarms and/or alerts) from individual railcars 110 to the locomotive engineer or an off-train management systems. The multi-purpose radio circuit 114 may be configured to receive information from different railcars 110, and make an inference about performance of the train consist 120. For instance, the multi-purpose radio circuit 114 may make certain determinations about accelerations, decelerations, impacts and alarm or alert transmissions when a train is in motion.

Each of the CMUs 400 may be capable of being a wireless node in the train-based network 500 and may be capable of sending messages to the locomotive 102 host or control point. For example, each CMU may store data or information that it may send to a remote processing device through a communications network. Each CMU may be capable of using built-in sensors and/or managing WSN(s) 404 to generate messages to be sent to the locomotive's 102 host or control point.

The train-based or railcar-based network may begin to form when a network manager (e.g., the multi-purpose radio circuit 114 for a train-based network and/or the CMU for a railcar-based network) begins sending “advertisements” or packets that contain information that enables a device to synchronize to the network and request to join. This message exchange is part of the security handshake that establishes encrypted communications between the manager and mote (e.g., a CMU for the train-based network or a WSN for the railcar-based network). The network manager may set the number of desired parents for each mote ensuring the existence of redundant communication paths. An ongoing discovery process ensures that the network continually discovers new paths as the radio conditions change. As segments of the communication path become unavailable (e.g., due to climate, environment, malfunction, etc.), the network is able to re-optimize and heal itself by employing the redundant and/or newly discovered radio paths.

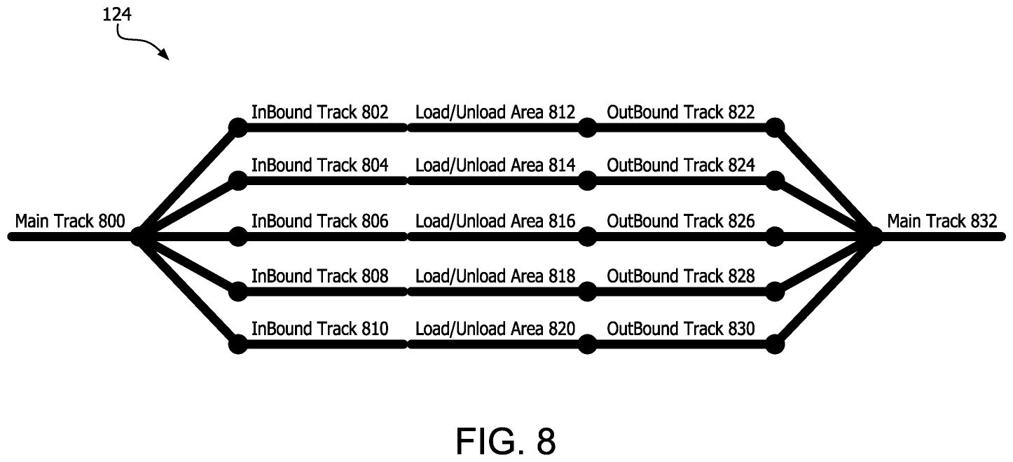

The particulars of the switch yard 104 will now be discussed in relation to FIG. 8. The switch yard 104 comprise one or more tracks 124. Railway assets may reside on the tracks 124. The railway assets can include, but are not limited to, locomotives and railcars.

An illustrative architecture for a set of tracks 124 is shown in FIG. 8. Track(s) 124 can include, but are not limited to, those shown in FIG. 8. More specifically, the tracks 124 of the switch yard 104 can include main tracks 800, 832, inbound tracks 802-810, and outbound tracks 822-830. Load/unload area(s) 812-818 and/or maintenance area(s) 820 can be designated between the inbound tracks 802-810 and the outbound tracks 822-830.

During operation, the train consist 120 enters the switch yard 104 via main track 800. The train consist 120 comprises a plurality of railcars 110 coupled to each other. The train consist 120 can include, but is not limited to, the locomotive 102. The train consist 120 is decoupled and disassembled on the main track 800 into individual railcars 110₁, 110₂, 110₃, 110₄, . . . , 110_{N}. The individual railcars are then moved to one or more of the inbound tracks 802-810, for example, based on their classifications, maintenance needs and/or train consist reassembly sequences which were previously communicated to the yard management system 116 from the multi-purpose radio circuit 114 when approaching the switch yard 104.

In prior art systems, individual(s) physically and manually inspect the railcars while on the inbound tracks 802-810. The number and/or type of such physical and manual inspections may be reduced since the multi-purpose radio circuit 114 may be configured to automate (i) railyard map updates with the locomotive location obtained from the PTC terminal 112 and/or railcar locations obtained from CMUs 400, (ii) maintenance inspections, and/or (iii) maintenance scheduling. The automated inspections can include, but are not limited to, wheelset inspections, hand brake inspections, piston pin travel inspections, spring nest inspections, bearing inspections, and/or railcar body appliance inspections. For example, the multi-purpose radio circuit 114 may be configured to collect and/or analyze sensor data from CMUs 400 and/or WSNs 404 to include but is not limited to (i) detect whether maintenance of a railcar is needed, (ii) detect whether or not handbrakes of the railcar(s) are set before loading/unloading operations are started in the load/unload areas 812-818, (iii) detect whether or not tank cars wheels are chocked before loading/unloading operations are started in the load/unload areas 812-818, (iv) detect any damage to the railcar (e.g., a crack in a wheelset, a car body, etc.), and/or (v) detect whether or not a valve or manway is closed and locked after completion of loading/unloading operations. Operations (i)-(v) can be performed prior to the train consist 120 entering the geofence 150 and/or while the train consist 120 is on the main track 800. Results from operations (i)-(v) are communicated from the multi-purpose radio circuit 114 to the yard management system 116 to assist with directing individual railcars 110 to specific inbound tracks 802-810 and/or pre-scheduling maintenance for the railcar(s) while in the switch yard 104. The maintenance can be performed in maintenance area 820.

The sensor data collected by the multi-purpose radio circuit 114 can be used by a machine learning algorithm to make predictions of future events relating to the railway asset. For example, the machine learning algorithm can process information specifying current conditions of components of a railcar to detect patterns which have been machine learned to lead to a particular event with a certain degree of likelihood or probability (e.g., a hairline crack in a wheel can lead to a derailment of the railcar with a certain degree of likelihood or probability that exceeds a threshold value, or an offset in a bracket position relative to a given reference point can lead to a mechanical failure of an axle with a certain degree of likelihood or probability that exceeds a threshold value). The threshold values may be obtained, selected or otherwise derived based historical data relating to actual occurrences of the particular events (e.g., actual railcar derailments) and/or simulation data relating to simulated events (e.g., simulated railcar derailments). The present solution is not limited to the particulars of this example.

The machine-learning algorithm(s) can employ supervised machine learning, semi-supervised machine learning, unsupervised machine learning, and/or reinforcement machine learning. Each of these listed types of machine-learning algorithms is well known in the art. In some scenarios, the machine-learning algorithm includes, but is not limited to, a decision tree learning algorithm, an association rule learning algorithm, an artificial neural network learning algorithm, a deep learning algorithm, an inductive logic programming based algorithm, a support vector machine based algorithm, a Bayesian network based algorithm, a representation learning algorithm, a similarity and metric learning algorithm, a sparse dictionary learning algorithm, a genetic algorithm, a rule-based machine-learning algorithm, and/or a learning classifier system based algorithm. The machine-learning process implemented by the present solution can be built using Commercial-Off-The-Shelf (COTS) tools (e.g., SAS available from SAS Institute Inc. of Cary, North Carolina).

The multi-purpose radio circuit 114 is configured to communicate with external device(s) via wireless communications for facilitating the automation of the above described processes/tasks. For example, the multi-purpose radio circuit 114 is configured to communicate with yard management system 116 via wireless communication links 606 of FIG. 6. The yard management system 116 can include, but is (are) not limited to, desktop computers, gateways, routers, mobile devices (e.g., radios, tablets, smart phones, etc.), and/or other devices. The wireless communications can include, but are not limited to, satellite communications, LRCs (e.g., cellular communications and/or WiFi communications) and/or SRCs (e.g., Bluetooth).

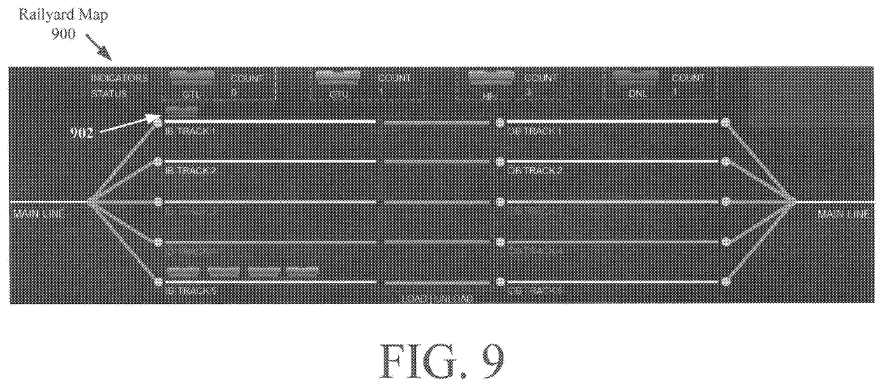

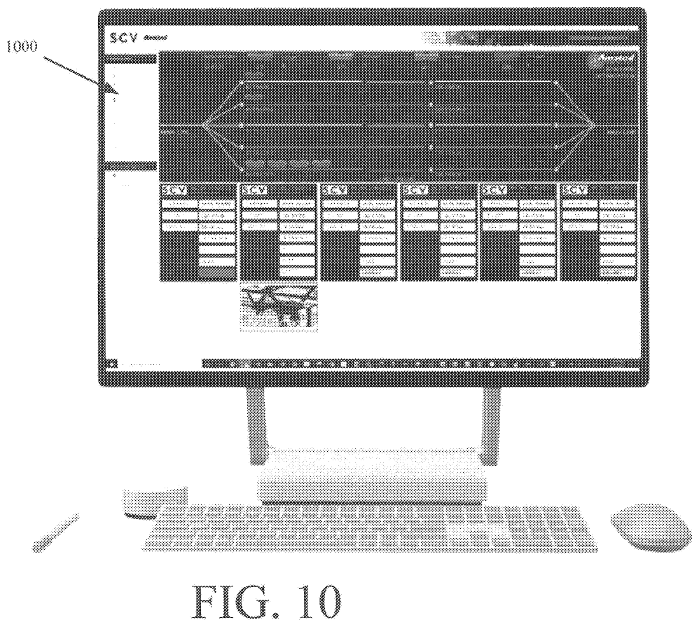

The multi-purpose radio circuit 114 is also configured to communicate with remote server(s) 608 via a network 600 (e.g., an Intranet or Internet). The remote server(s) 528 is (are) configured to (i) facilitate access to and storage of data in datastore(s) 610 (e.g., a database), and/or (ii) facilitate the provision of notifications and/or alerts to computing device(s) 612 of the yard management system 116 being used by, for example, site supervisor(s) or manager(s) 118. The notifications and/or alerts can concern detected defects of railway assets, maintenance scheduling for railway assets, locations of railway assets, statuses of railway assets, detected unusual activity in the switch yard 104, automated inspection statuses, automated inspection results, security check statuses, security check results, and/or requirement satisfaction/compliance. The remote server(s) 608 can use this information to update railyard maps and/or railyard GUIs in real time or near real time. Illustrative GUIs are shown in FIGS. 9-10.

Once the loading/unloading, maintenance or other railcar-related task(s) is (are) completed, the railcar is moved to an outbound track (e.g., outbound track 822 of FIG. 8). The railcar is then moved to the main track 832 in accordance with a train consist reassembly sequence. The train consist may then be assembled, verified by the multi-purpose radio circuit 114, and leave the switch yard 104 via main track 832.

An illustrative railyard map 900 is shown in FIG. 9. The railyard map 900 comprises railcar icons 902 arranged to show current locations of railcars on tracks of the switch yard and to show relative positions (or sequenced order) of railcars on each track. An illustrative GUI 1000 showing content of recognized markings (e.g., railcar mark, load limit, and tare weight), railcar location/position information (e.g., track 1, position 1), and collected railcar status information (e.g., passed/failed inspection, was/was not unloaded/loaded) is provided in FIG. 10.

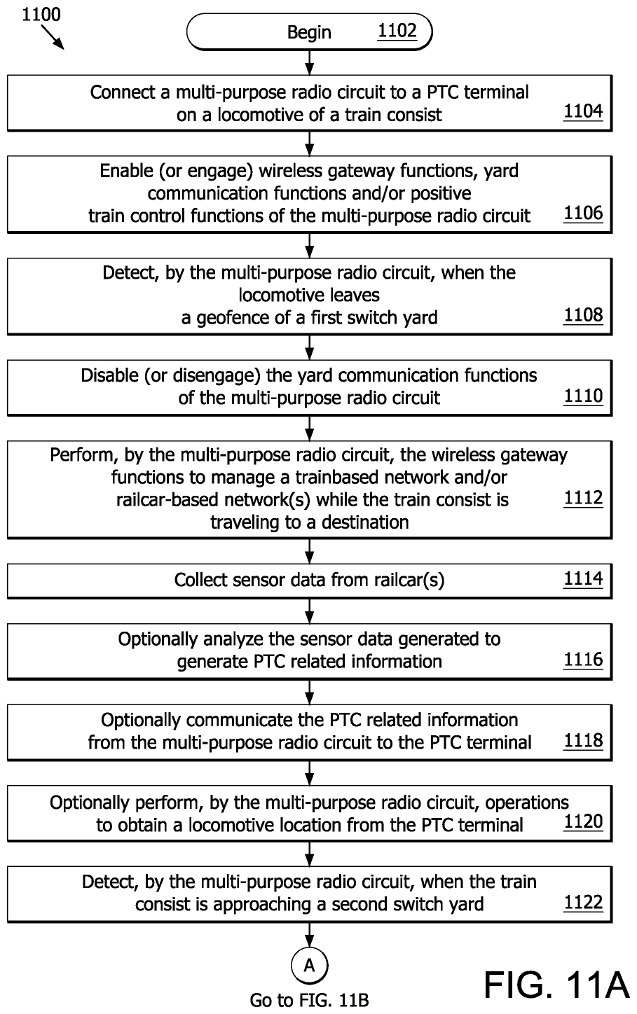

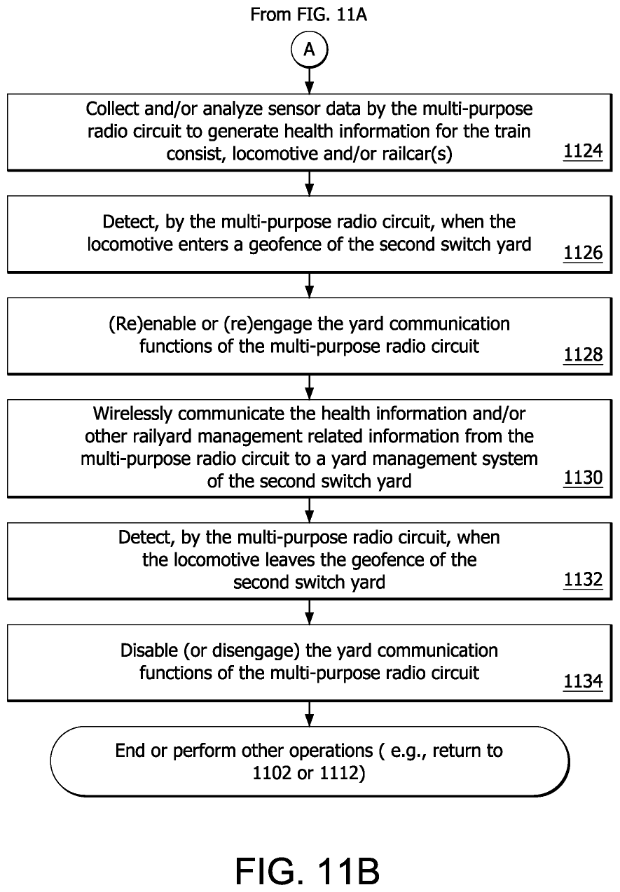

FIG. 11 provides a flow diagram of an illustrative method 1100 for operating a multi-purpose radio circuit (e.g., multi-purpose radio circuit 114 of FIG. 1) to provide at least a connected switch yard and train consist management system. Method 1100 begins with 1102 and continues with 1104 where the multi-purpose radio circuit is connected to a PTC terminal (e.g., PTC terminal 112 of FIG. 1) on a locomotive (e.g., locomotive 102 of FIG. 1) of a train consist (e.g., train consist 120 of FIG. 1). The multi-purpose radio circuit is turned on, supplied power, enabled and/or otherwise engaged in block 1106. As such, the following functions of the multi-purpose radio circuit are enabled or engaged: wireless gateway functions, yard communication functions, and/or positive train control functions. The wireless gateway functions are configured to facilitate management of a train-based network (e.g., train-based network 500 of FIG. 5) and/or railcar-based network(s) (e.g., railcar-based networks 502 of FIG. 5). The yard communication functions are configured to facilitate wireless communications between the multi-purpose radio circuit and a yard management system (e.g., yard management system 116 of FIG. 1). The positive train control functions are configured to facilitate the communication and/or exchange of information between the multi-purpose radio circuit and a PTC terminal (e.g., PTC terminal 112 of FIG. 1).

In block 1108, the multi-purpose radio circuit detects when the locomotive leaves a geofence of a first switch yard. Any known or to be known technique for detecting when an electronic device leaves a geofence can be used here. Responsive to such detection, the multi-purpose radio circuit disables or disengages its yard communication functions as shown by block 1110. Notably, the wireless gateway functions remain enabled or engaged when the locomotive is outside of the geofence of a first switch yard. Accordingly, the multi-purpose radio circuit performs wireless gateway functions in block 1112 to manage the train-based network and the railcar-based network(s) of the train consist. Any known or to be known technique for managing train-based networks and railcar-based network(s) can be used here.

The multi-purpose radio circuit also performs operations in 1114 to collect sensor data from sensor(s) (e.g., sensor(s) 140 and/or 142 of FIG. 1) of the railcar(s) (e.g., railcar(s) 110 of FIG. 1) and/or locomotive. The sensor data may be analyzed in block 1116 to generate PTC related information. The PTC related information comprises any information that facilitates prevention of train-to-train collisions, over-speed derailments, incursions into established work zones, and movements of trains through switches left in the wrong position. Such information includes, but is not limited to, health data for the train consist, locomotive and/or railcar(s). The health data can include, but is not limited to, hand brake status data (e.g., on or off), hatch status data (e.g., closed or open), load temperature data, bearing temperature data, wheel damage data, railcar body damage data, and/or track/route anomaly data. The PTC related information may be communicated in block 1118 from the multi-purpose radio circuit to the PTC terminal.

In block 1120, the multi-purpose radio circuit may obtain a locomotive location from the PTC terminal. The locomotive location can be expressed by GPS coordinates. This location can be used in block 1122 to detect when the train consist is approaching a second switch yard (e.g., switch yard 104 of FIG. 1). Next, method 1100 continues to block 1124 of FIG. 11B.

As shown in FIG. 11B, block 1124 involves collecting and/or analyzing sensor data by the multi-purpose radio circuit to generate health information and/or updated heath information. The health information can include, but is not limited to, a hand brake status (e.g., on or off), a hatch status (e.g., closed or open), a load temperature, a bearing temperature, wheel condition, wheel damage, railcar body damage, load status, and/or track/route anomalies.

In block 1126, the multi-purpose radio circuit detects when the locomotive enters a geofence (e.g., geofence 150 of FIG. 1) of the second switch yard. Any known or to be known technique for detecting when an electronic device enters a geofence can be used here.

In response to this detection, the yard communication functions of the multi-purpose radio circuit are (re) enabled or (re) engaged in block 1128. As such, the multi-purpose radio circuit is able to wirelessly communicate with the yard management system (e.g., yard management system 116 of FIG. 1) of the second switch yard. Accordingly, the health information generated in 1124 is communicated from the multi-purpose radio circuit to the yard management system of the second switch yard as shown by block 1130. Other railyard management related information can additionally or alternatively be sent from the multi-purpose radio circuit to the yard management system of the second switch yard. The other railyard management related information can include, but is not limited to, an estimated time of arrival (ETA), a train consist makeup, train consist maintenance information, track/route anomaly information, and/or environmental data. Train consist makeup can include, but is not limited to, a number of railcars, railcar order, railcar types, and/or cargo types. The health information and/or railyard management related information is intended to include, but is not limited to, (i) provide advance notice to the switch yard manager(s) (e.g., manager(s) 118 of FIG. 1) to prepare for railcars that need to be switched out of and/or into the train consist, (ii) alert the switch yard to potential maintenance needs, and/or (iii) facilitate provision of certain information (e.g., track/route anomalies, weather events, etc.) to other train consists in, on route to, and/or leaving the second switch yard.

In block 1132, the multi-purpose radio circuit detects when the locomotive leaves the geofence of the second switch yard. Responsive to such detection, the yard communication functions of the multi-purpose radio circuit are disabled (or disengaged). Subsequently, method 1100 continues to block 1136 where method 1100 ends or other operations are performed. The other operations can include, but are not limited to, returning to block 1102 or block 1112 of FIG. 11A.

In view of the forgoing discussion, the present solution concerns implementing systems and methods for operating a multi-purpose radio circuit (e.g., multi-purpose radio circuit 114 of FIG. 1) of a locomotive (e.g., locomotive 102 of FIG. 1). The methods comprise: (i) establishing a connection between the multi-purpose radio circuit and a positive train control terminal (e.g., positive train control terminal 112 of FIG. 1) located on the locomotive of a train consist (e.g., train consist 120 of FIG. 1) (wherein a yard communication function of the multi-purpose radio circuit is disabled and a wireless gateway function of the multi-purpose radio circuit is enabled); (ii) performing the wireless gateway function by the multi-purpose radio circuit to manage a train-based network (e.g., train-based network 500 of FIG. 5) of the train consist and/or a railcar-based network (e.g., railcar-based network 502 of FIG. 5) of a railcar (e.g., railcar 110 of FIG. 1) of the train consist while the train consist is in route to a switch yard (e.g., switch yard 104 of FIG. 1); (iii) detecting, by the multi-purpose radio circuit, that the locomotive is entering a geofence (e.g., geofence 150 of FIG. 1) of the switch yard; (iv) enabling the yard communication function of the multi-purpose radio circuit responsive to said detecting; and (v) performing the yard communication function to wirelessly communicate information from the multi-purpose radio circuit that is useful for switch yard management. The connection of feature (i) may be established by plugging the multi-purpose radio circuit in a circuit card slot (e.g., circuit card slot 190 of FIG. 1) of the positive train control terminal. The information of feature (v) can include, but is not limited to, health information, an estimated time of arrival, a train consist makeup, train consist maintenance information, track or route anomaly information, and/or environmental data.

The multi-purpose radio circuit may have at least the following purposes: manage the train-based network and/or a railcar-based network of the train consist; and facilitate switch yard management. The switch yard management can include, but is not limited to, decoupling and disassembling train consist(s) on a main track into individual railcars; moving individual railcars to inbound track(s), automatedly or autonomously inspecting the individual railcars on the inbound track(s), automatedly or autonomously update railyard map(s) with the locomotive and/or railcar location(s), automatedly or autonomously perform maintenance inspections of the locomotive and/or individual railcar(s), automatedly or autonomously perform maintenance scheduling for the locomotive and/or individual railcar(s), moving individual railcars to load/unload area(s), moving individual railcar(s) to outbound track(s), and/or (re) assembling train consist(s). The multi-purpose radio circuit may be configured to use a same communication technology or different communication technologies for wireless communications with nodes of a train-based network and nodes of a switch yard-based network.

The methods may also involve: receiving, by the multi-purpose radio circuit, a location from the positive train control terminal (wherein the location is used during said detecting); disabling the yard communication function in response to the locomotive leaving the geofence of the switch yard; and/or supplying power from the positive train control terminal to the multi-purpose radio circuit. Additionally or alternatively, the methods may involve: receiving, by the multi-purpose radio circuit, sensor data from at least one sensor of the train consist; and communicating the sensor data or health information derived using the sensor data from the multi-purpose radio circuit to the positive train control terminal.

Additionally or alternatively, the methods may involve: detecting, by the multi-purpose radio circuit, an approachment of the train consist to the switch yard; and collecting sensor data or health information from a plurality of wireless sensor nodes disposed on railcars of the train consist, responsive to said approachment. The information wirelessly communicated from the multi-purpose radio circuit to the yard management system may comprise the collected sensor data or health information.

The present solution also concerns a system, comprising: a positive train control terminal (e.g., positive train control terminal 112 of FIG. 1); and a multi-purpose radio circuit (e.g., multi-purpose radio circuit 114 of FIG. 1) that is electrically connected the positive train control terminal. The multi-purpose radio circuit is configured to: (i) perform a wireless gateway function to manage a train-based network (e.g., train-based network 500 of FIG. 5) of a train consist (e.g., train consist 120 of FIG. 1) and/or a railcar-based network (e.g., railcar-based network 502 of FIG. 5) of a railcar (e.g., railcar 110 of FIG. 1) of the train consist; (ii) detect that a locomotive (e.g., locomotive 102 of FIG. 1) is entering a geofence (e.g., geofence 150 of FIG. 1) of a switch yard (e.g., switch yard 104 of FIG. 1); (iii) enable a yard communication function responsive to a detection that the locomotive is entering the geofence of the switch yard; and (iv) perform the yard communication function to wirelessly communicate information from the multi-purpose radio circuit that is useful for switch yard management. The information can include, but is not limited to, health information, an estimated time of arrival, a train consist makeup, train consist maintenance information, track or route anomaly information, and/or environmental data.

The positive train control terminal and the multi-purpose radio circuit may both be disposed on the locomotive of the train consist. The multi-purpose radio circuit may have at least the following purposes: manage a train-based network and/or a railcar-based network of the train consist; and facilitate switch yard management. The system multi-purpose radio circuit may be further configured to receive a location from the positive train control terminal, and wherein the location is used during said detecting. The multi-purpose radio circuit may be plugged into a circuit card slot or port (e.g., circuit card slot or port 190 of FIG. 1) of the positive train control terminal. The multi-purpose radio circuit may be a plug-and-play device. The multi-purpose radio circuit may also be configured to disable the yard communication function in response to the locomotive leaving the geofence of the switch yard.

The multi-purpose radio circuit may be configured to: receive sensor data from at least one sensor of the train consist; and communicate the sensor data or health information derived using the sensor data from the multi-purpose radio circuit to the positive train control terminal. Additionally or alternatively, the multi-purpose radio circuit is further configured to: detect an approachment of the train consist to the switch yard; and collect sensor data or health information from a plurality of wireless sensor nodes and/or CMUs disposed on railcars of the train consist, responsive to said approachment. The information wirelessly communicated from the multi-purpose radio circuit to the yard management system may include the collected sensor data or health information.

Additionally or alternatively, the multi-purpose radio circuit may be configured to use a same communication technology or different communication technologies for wireless communications with nodes of a train-based network and nodes of a switch yard-based network. The positive train control terminal may be configured to supply power to the multi-purpose radio circuit.

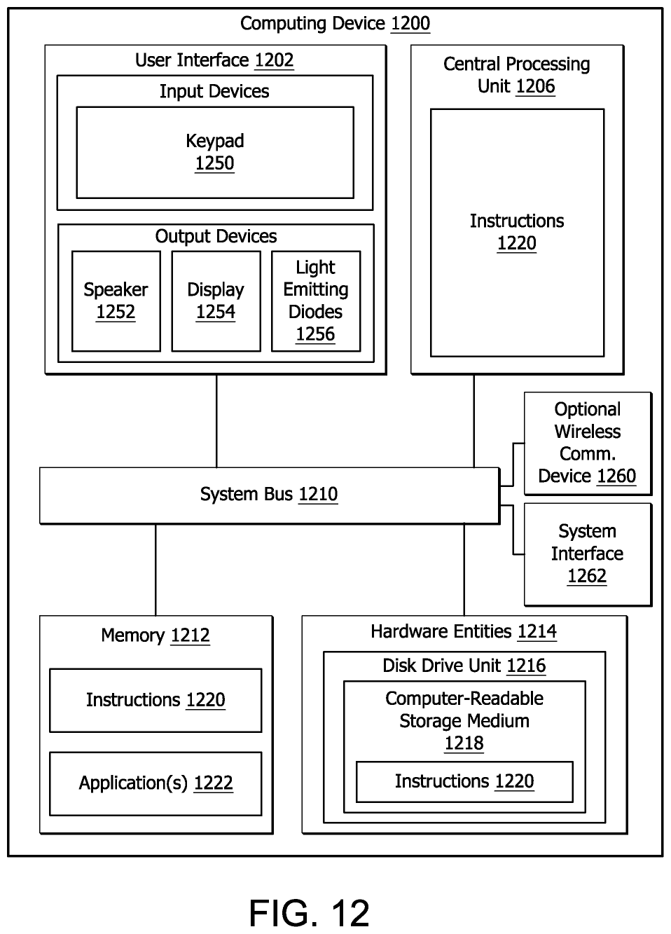

FIG. 12 provides a detailed block diagram of an illustrative architecture for the computing device 1200. The PTC terminal 112 of FIG. 1, multi-purpose radio circuit 114 of FIG. 1, yard management system 116 of FIG. 1, base station 132 of FIG. 1, CMU(s) 400 of FIG. 4), WSN(s) 404 of FIG. 4, remote processing device(s) 602 of FIG. 6, remote railroad operations center 604 of FIG. 6, server(s) 608 of FIG. 6, and/or computing device(s) 612 of FIG. 6 is/are the same as or similar to computing device 1200. As such, the discussion of computing device 1200 is sufficient for understanding devices 112, 114, 116, 132, 400, 404, 602 and 604 mentioned above.

Computing device 1200 may include more or less components than those shown in FIG. 12. However, the components shown are sufficient to disclose an illustrative embodiment implementing the present solution. The hardware architecture of FIG. 12 represents one embodiment of a representative computing device configured to facilitate system management of railcar(s) and data collection unit(s). As such, the computing device 1200 of FIG. 12 implements at least a portion of the methods described herein for associating a railcar to a data collection unit.

Some or all the components of the computing device 1200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 12, the computing device 1200 comprises a user interface 1202, a CPU 1206, a system bus 1210, a memory 1212 connected to and accessible by other portions of computing device 1200 through system bus 1210, and hardware entities 1214 connected to system bus 1210. The user interface can include input devices (e.g., a keypad 1250) and output devices (e.g., speaker 1252, a display 1254, and/or light emitting diodes 1256), which facilitate user-software interactions for controlling operations of the computing device 1200.

At least some of the hardware entities 1214 perform actions involving access to and use of memory 1212, which can be a RAM. Hardware entities 1214 can include a disk drive unit 1216 comprising a computer-readable storage medium 1218 on which is stored one or more sets of instructions 1220 (e.g., software code) configured to implement one or more of the methodologies, procedures, or functions described herein. The instructions 1220 can also reside, completely or at least partially, within the memory 1212 and/or within the CPU 1206 during execution thereof by the computing device 1200. The memory 1212 and the CPU 1206 also can constitute machine-readable media. The term “machine-readable media”, as used here, refers to a single medium or multiple media (e.g., a centralized or distributed database, and/or associated caches and servers) that store the one or more sets of instructions 1220. The term “machine-readable media”, as used here, also refers to any medium that is capable of storing, encoding or carrying a set of instructions 1220 for execution by the computing device 1200 and that cause the computing device 1200 to perform any one or more of the methodologies of the present disclosure.

In some scenarios, the hardware entities 1214 include an electronic circuit (e.g., a processor) programmed for facilitating the association of a railcar to a data collection unit. In this regard, it should be understood that the electronic circuit can access and run a software application 1222 installed on the computing device 1200.

A wireless communication device 1260 and/or a system interface 1262 may also be provided with the computing device 1200. The wireless communication device 1260 is configured to facilitate wireless communications between the computing device 1200 and external devices (e.g., device(s) 602, 604, 608, 612 of FIG. 6). The wireless communications can include, but are not limited to, NFCs, SRCs (e.g., WiFi, Bluetooth, and/or LoRA), satellite communications, and/or cellular communications. The system interface 1262 is configured to facilitate wired and/or wireless communications between the computing device 1200 and external devices (e.g., device(s) 602, 604, 608, 612 of FIG. 6). In this regard, the system interface 1262 can include, but is not limited to, an Ethernet interface, an RS232 interface, an RS422 interface, and/or a USB interface.

Without excluding further possible embodiments, certain example embodiments are summarized in the following clauses.
Clause 1: A method for operating a multi-purpose radio circuit of a locomotive, comprising: establishing a connection between the multi-purpose radio circuit and a positive train control terminal located on the locomotive of a train consist (wherein a yard communication function of the multi-purpose radio circuit is disabled and a wireless gateway function of the multi-purpose radio circuit is enabled); performing the wireless gateway function by the multi-purpose radio circuit to manage a train-based network of the train consist and/or a railcar-based network of a railcar of the train consist while the train consist is in route to a switch yard; detecting, by the multi-purpose radio circuit, that the locomotive is entering a geofence of the switch yard; enabling the yard communication function of the multi-purpose radio circuit responsive to said detecting; and performing the yard communication function to wirelessly communicate information from the multi-purpose radio circuit that is useful for switch yard management.
Clause 2: The method of Clause 1, wherein the multi-purpose radio circuit has at least the following purposes: manage a train-based network and/or a railcar-based network of the train consist; and facilitate switch yard management. The switch yard management can include, but is not limited to, decoupling and disassembling train consist(s) on a main track into individual railcars; moving individual railcars to inbound track(s), automatedly or autonomously inspecting the individual railcars on the inbound track(s), automatedly or autonomously update railyard map(s) with the locomotive and/or railcar location(s), automatedly or autonomously perform maintenance inspections of the locomotive and/or individual railcar(s), automatedly or autonomously perform maintenance scheduling for the locomotive and/or individual railcar(s), moving individual railcars to load/unload area(s), moving individual railcar(s) to outbound track(s), and/or (re) assembling train consist(s).
Clause 3: The method of any of the preceding method clauses, further comprising receiving, by the multi-purpose radio circuit, a location from the positive train control terminal, wherein the location is used during said detecting.
Clause 4: The method of any of the preceding method clauses, wherein the information comprises at least one of health information, an estimated time of arrival, a train consist makeup, train consist maintenance information, track or route anomaly information, and environmental data.
Clause 5: The method of any of the preceding method clauses, wherein the connection is established by plugging the multi-purpose radio circuit in a circuit card slot of the positive train control terminal.
Clause 6: The method of any of the preceding method clauses, further comprising disabling the yard communication function in response to the locomotive leaving the geofence of the switch yard.
Clause 7: The method of any of the preceding method clauses, further comprising: receiving, by the multi-purpose radio circuit, sensor data from at least one sensor of the train consist; and communicating the sensor data or health information derived using the sensor data from the multi-purpose radio circuit to the positive train control terminal.
Clause 8: The method of any of the preceding method clauses, further comprising: detecting, by the multi-purpose radio circuit, an approachment of the train consist to the switch yard; and collecting sensor data or health information from a plurality of wireless sensor nodes disposed on railcars of the train consist, responsive to said approachment. The information wirelessly communicated from the multi-purpose radio circuit to the yard management system comprises the collected sensor data or health information.
Clause 9: The method of any of the preceding method clauses, wherein the multi-purpose radio circuit is configured to use a same communication technology or different communication technologies for wireless communications with nodes of a train-based network and nodes of a switch yard-based network.
Clause 10: The method of any of the preceding method clauses, further comprising supplying power from the positive train control terminal to the multi-purpose radio circuit.
Clause 11: A system, comprising: a positive train control terminal; and a multi-purpose radio circuit that is electrically connected the positive train control terminal and configured to: (i) perform a wireless gateway function to manage a train-based network of a train consist and/or a railcar-based network of a railcar of the train consist; (ii) detect that a locomotive is entering a geofence of a switch yard; (iii) enable a yard communication function responsive to a detection that the locomotive is entering the geofence of the switch yard; and (iv) perform the yard communication function to wirelessly communicate information from the multi-purpose radio circuit that is useful for switch yard management.
Clause 12: The system according to Clause 11, wherein the positive train control terminal and the multi-purpose radio circuit are both disposed on the locomotive of the train consist.
Clause 13: The system according to any of the preceding system clauses, wherein the multi-purpose radio circuit has at least the following purposes: manage a train-based network and/or a railcar-based network of the train consist; and facilitate switch yard management.
Clause 14: The system according to any of the preceding system clauses, wherein the multi-purpose radio circuit is further configured to receive a location from the positive train control terminal, and wherein the location is used during said detecting.
Clause 15: The system according to any of the preceding system clauses, wherein the information comprises at least one of health information, an estimated time of arrival, a train consist makeup, train consist maintenance information, track or route anomaly information, and environmental data.
Clause 16: The system according to any of the preceding system clauses, wherein the multi-purpose radio circuit is plugged into a circuit card slot or port of the positive train control terminal.
Clause 17: The system according to any of the preceding system clauses, wherein the multi-purpose radio circuit is a plug-and-play device.
Clause 18: The system according to any of the preceding system clauses, wherein the multi-purpose radio circuit is further configured to disable the yard communication function in response to the locomotive leaving the geofence of the switch yard.
Clause 19: The system according to any of the preceding system clauses, wherein the multi-purpose radio circuit is further configured to: receive sensor data from at least one sensor of the train consist; and communicate the sensor data or health information derived using the sensor data from the multi-purpose radio circuit to the positive train control terminal.
Clause 20: The system according to any of the preceding system clauses, wherein the multi-purpose radio circuit is further configured to: detect an approachment of the train consist to the switch yard; and collect sensor data or health information from a plurality of wireless sensor nodes disposed on railcars of the train consist, responsive to said approachment.
Clause 21: The system according to any of the preceding system clauses, wherein the information wirelessly communicated from the multi-purpose radio circuit to the yard management system comprises the collected sensor data or health information.
Clause 22: The system according to any of the preceding system clauses, wherein the multi-purpose radio circuit is further configured to use a same communication technology or different communication technologies for wireless communications with nodes of a train-based network and nodes of a switch yard-based network.
Clause 23: The system according to any of the preceding system clauses, wherein the positive train control terminal is configured to supply power to the multi-purpose radio circuit.

The breadth and scope of this disclosure should not be limited by any of the above-described example embodiments, but should be defined only in accordance with the following claims and their equivalents.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for operating a multi-purpose radio circuit of a locomotive, comprising:
establishing a connection between the multi-purpose radio circuit and a positive train control terminal located on the locomotive of a train consist, wherein a yard communication function of the multi-purpose radio circuit is disabled and a wireless gateway function of the multi-purpose radio circuit is enabled;
performing the wireless gateway function by the multi-purpose radio circuit to manage a network of the train consist and/or a railcar of the train consist while the train consist is in route to a switch yard;
detecting, by the multi-purpose radio circuit, that the locomotive is entering a geofence of the switch yard;
enabling the yard communication function of the multi-purpose radio circuit responsive to said detecting; and
performing the yard communication function to wirelessly communicate information from the multi-purpose radio circuit that is useful for switch yard management.

2. The method according to claim 1, wherein the multi-purpose radio circuit has at least the following purposes: manage a train-based network and/or a railcar-based network of the train consist; and facilitate switch yard management.

3. The method according to claim 1, further comprising:
receiving, by the multi-purpose radio circuit, a location from the positive train control terminal;
wherein the location is used during said detecting.

4. The method according to claim 1, wherein the information comprises at least one of health information, an estimated time of arrival, a train consist makeup, train consist maintenance information, track or route anomaly information, and environmental data.

5. The method according to claim 1, wherein the connection is established by plugging the multi-purpose radio circuit in a circuit card slot of the positive train control terminal.

6. The method according to claim 1, further comprising disabling the yard communication function in response to the locomotive leaving the geofence of the switch yard.

7. The method according to claim 1, further comprising:
receiving, by the multi-purpose radio circuit, sensor data from at least one sensor of the train consist; and
communicating the sensor data or health information derived using the sensor data from the multi-purpose radio circuit to the positive train control terminal.

8. The method according to claim 1, further comprising:
detecting, by the multi-purpose radio circuit, an approachment of the train consist to the switch yard;
responsive to said approachment, collecting sensor data or health information from one or more sensors disposed on at least one railcar of the train consist;
wherein the information wirelessly communicated from the multi-purpose radio circuit to the yard management system comprises the collected sensor data or health information.

9. The method according to claim 1, wherein the multi-purpose radio circuit is configured to use a same communication technology or different communication technologies for wireless communications with nodes of a train-based network and nodes of a switch yard-based network.

10. The method according to claim 1, further comprising supplying power from the positive train control terminal to the multi-purpose radio circuit.

11. A system, comprising:
a positive train control terminal; and
a multi-purpose radio circuit that is electrically connected to the positive train control terminal and configured to perform the following functions when a yard communication function of the multi-purpose radio circuit is disabled and a wireless gateway function of the multi-purpose radio circuit is enabled:
(i) perform a wireless gateway function to manage a network of a train consist and or a railcar of the train consist while the train consist is in route to a switch yard;
(ii) detect that a locomotive is entering a geofence of a switch yard;
(iii) enable a yard communication function responsive to a detection that the locomotive is entering the geofence of the switch yard; and
(iv) perform the yard communication function to wirelessly communicate information from the multi-purpose radio circuit that is useful for switch yard management.

12. The system according to claim 11, wherein the positive train control terminal and the multi-purpose radio circuit are both disposed on the locomotive of the train consist.

13. The system according to claim 11, wherein the multi-purpose radio circuit has at least the following purposes: manage a train-based network and/or a railcar-based network of the train consist; and facilitate switch yard management.

14. The system according to claim 11, wherein the multi-purpose radio circuit is further configured to receive a location from the positive train control terminal, and wherein the location is used during said detecting.

15. The system according to claim 11, wherein the information comprises at least one of health information, an estimated time of arrival, a train consist makeup, train consist maintenance information, track or route anomaly information, and environmental data.

16. The system according to claim 11, wherein the multi-purpose radio circuit is plugged into a circuit card slot or port of the positive train control terminal.

17. The system according to claim 16, wherein the multi-purpose radio circuit is a plug-and-play device.

18. The system according to claim 11, wherein the multi-purpose radio circuit is further configured to disable the yard communication function in response to the locomotive leaving the geofence of the switch yard.

19. The system according to claim 11, wherein the multi-purpose radio circuit is further configured to:
receive sensor data from at least one sensor of the train consist; and
communicate the sensor data or health information derived using the sensor data from the multi-purpose radio circuit to the positive train control terminal.

20. The system according to claim 11, wherein the multi-purpose radio circuit is further configured to:
detect an approachment of the train consist to the switch yard; and
responsive to said approachment, collect sensor data or health information from one or more sensors disposed on at least one railcar of the train consist.

21. The system according to claim 20, wherein the information wirelessly communicated from the multi-purpose radio circuit to the yard management system comprises the collected sensor data or health information.

22. The system according to claim 11, wherein the multi-purpose radio circuit is further configured to use a same communication technology or different communication technologies for wireless communications with nodes of a train-based network and nodes of a switch yard-based network.

23. The system according to claim 11, wherein the positive train control terminal is configured to supply power to the multi-purpose radio circuit.
